(19) United States
(12) Patent Application Publication
(10) Pub. No.: US 2026/0109095 A1
(43) Pub. Date: Apr. 23, 2026

(54) PRODUCT FORMING SYSTEM WITH ELECTRICALLY HEATED MOULD, INCLUDING MEASUREMENT DEVICE FOR MEASURING CURRENT, AND METHOD

(71) Applicant: AMS Belgium, Bilzen (BE)

(72) Inventors: Johan Potargent, Bilzen (BE); Laurens Potargent, Bilzen (BE)

(73) Assignee: AMS Belgium, Bilzen (BE)

(21) Appl. No.: 19/117,648

(22) PCT Filed: Nov. 20, 2023
(86) PCT No.: PCT/IB2023/061683

§ 371 Date: Apr. 2, 2025

(30) Foreign Application Priority Data
Nov. 21, 2022 (BE) 2022/5934

(51) Int. Cl. B29C 45/73; B29C 41/04; B29C 41/46; B29C 41/52

(52) U.S. Cl. CPC B29C 45/7306; B29C 41/04; B29C 41/46; B29C 41/52

(57) ABSTRACT

Product forming system, e.g. by a rotational moulding process, comprising an electrically heated mould of which at least one mould part is provided with a plurality of electrical resistors for heating a cavity inside the mould, means for applying electric current to the electrical resistors, and a measurement device for measuring the electric current flowing through the electric resistors. The measurement device comprises a plurality of openings, with at least one electrical conductor running through each opening, each of which is connected in series to at least one of the electrical resistors. At each opening, an inductive element is provided for measuring the electric current through the respective at least one electrical conductor. The measurement device comprises electronic components for converting the measured currents into measurement data and for storing and/or transmitting the measurement data.

### TECHNICAL AREA

This invention relates to a system for forming products, preferably from a thermoplastic material, the system comprising an electrically heated mould and a measurement device for measuring electric current flowing through electrical resistors provided on the mould.

### BACKGROUND ART

US5322654A describes a system for forming products by means of a rotational moulding process. The system comprises a feedback tool for real-time monitoring and control of the moulding method based on a measurement device that is placed in the mould to measure the temperature.

WO0180671A1 describes an injection moulding system, comprising an electric heating device with a number of heating elements and a measurement device for measuring the resistor or inductance of the electric heating elements. The measurement is done by sampling a measured value.

### SUMMARY OF THE INVENTION

It is a first aim of the invention to provide a simple system and method for measuring electric current flowing through electrical resistors provided on the mould.

It is a second aim of the present invention to provide a simple system and method of operation for detecting defects or wear of electric heating resistors provided on a mould.

In a first aspect, which may be combined with other aspects and/or embodiments described herein, the invention relates to a product forming system, e.g. by means of a rotational moulding process, comprising an electrically heated mould of which at least one mould part is equipped with a plurality of electrical resistors for heating a cavity inside the mould, means for applying electric current to the electrical resistors, and a measurement device for measuring the electric current flowing through the electrical resistors.

According to the invention, the measurement device is preferably integrated on the mould part. The measurement device comprises a plurality of openings, with at least one electrical conductor running through each opening, each of which is connected in series to at least one of the electrical resistors. At each opening, an inductive element is provided for measuring the electric current through the respective at least one electrical conductor. The measurement device comprises electronic components for converting the measured currents into measurement data and for storing and/or transmitting the measurement data.

In embodiments according to the invention, the measurement device may include a printed circuit board, wherein the openings and the inductive elements are provided on the circuit board.

In embodiments according to the invention, the inductive elements may be (alternating) current transformers. This has the advantage that the currents flowing through the conductors can be used as a power supply for the measurement device and there is no need to provide a separate power source in the measurement device. In other embodiments, however, the measurement device may also be equipped with its own power source, such as a battery.

In embodiments according to the invention, one conductor may run through each opening and/or each conductor may be connected in series to each time one of the electrical resistors. In embodiments according to the invention, each inductive element is preferably provided for measuring the current through each time one of the resistors.

In embodiments according to the invention, a number of conductors may run through each opening and/or each conductor may be connected to a number of the resistors. With these embodiments, the current through each conductor may be determined in a number of successive measurement steps. For example, in a first measurement step, the current may be measured through a group of resistors and compared with one or more threshold values. Subsequently, in a second measurement step for the group(s) with deviating measurement values, the current per resistor may be measured by separately applying and measuring the current through the resistors of the group one by one.

In embodiments according to the invention, the system may comprise a control unit provided for controlling the measurement device to perform current measurements.

In embodiments according to the invention, the control unit may be provided for controlling the measurement device to perform a current measurement at least at the beginning and/or the end of each production cycle.

In embodiments according to the invention, the control unit may be provided for controlling the measurement device to perform current measurements during a production cycle, preferably at regular intervals.

In embodiments according to the invention, the electronic components of the measurement device may include a transmitting receiver provided for the wireless transmission of the measurement data and/or the wireless reception of control signals.

In a second aspect, which may be combined with other aspects and/or embodiments described herein, the invention relates to a method for measuring currents through electric heating resistors on a mould, wherein a measurement device is provided on a mould part, preferably in a system as described above, wherein the method comprises the step of controlling the measurement device, which is integrated on the mould part, to perform a current measurement at least at the beginning and/or end of each production cycle.

In embodiments according to the invention, the method may include the step of controlling the measurement device to perform current measurements during a production cycle, preferably at regular intervals.

In embodiments according to the invention, each current measurement may have a duration of 1 to 60 seconds, preferably 2 to 30 seconds, more preferably 5 to 10 seconds. For example, in the case of periodic measurements, the current measurements may be repeated at an interval of 20, 30, 40, 50, 60 or more seconds, or every 1, 2, 3 or more minutes, preferably a current measurement with a duration of 5 to 10 seconds once every minute.

In embodiments according to the invention, the current measurements may be repeated periodically during the production cycle or triggered when one or more predetermined threshold values for the temperature in the mould or mould wall is/are reached.

### BRIEF DESCRIPTION OF THE DRAWINGS

The invention will be explained in more detail below on the basis of embodiments according to the invention depicted in the drawings.

FIG. 1 shows a schematic overview of an embodiment of a system according to the invention.

FIGS. 2, 3 and 4 schematically show alternative embodiments of a system according to the invention.

FIG. 5 shows a photograph of an embodiment of a measurement device suitable for use in a system or method according to the invention.

### DESCRIPTION OF EMBODIMENTS

In the following, certain embodiments according to the invention are described with reference to certain drawings, but the invention is not limited thereto. The drawings described are only schematic and non-limiting. In the drawings, the size of certain elements may be exaggerated and not drawn to scale for illustrative purposes. The dimensions and relative dimensions do not necessarily correspond to actual reductions to practice of the invention.

In addition, the terms first, second, third and the like are used in the description and in the claims to distinguish between similar elements and not necessarily to describe a sequential or chronological order. The terms are interchangeable under appropriate circumstances and the embodiments of the invention may be applied in sequences other than those described or illustrated herein.

In addition, the terms top, bottom, over, bottom, etc. are used in the description and claims for illustrative purposes and not necessarily to describe relative positions. The terms thus used are interchangeable under appropriate circumstances and the embodiments of the invention described herein may be applied in orientations other than those described or illustrated herein.

Furthermore, the various embodiments, although referred to as ‘preferred embodiments’, should be understood as an example of how the invention can be carried out rather than as a limitation of the scope of the invention.

The term ‘comprising’ used in the claims should not be construed as being limited to the means or steps mentioned thereafter; the term does not exclude other elements or steps. The term shall be interpreted as specifying the presence of the mentioned features, elements, steps or components, but does not exclude the presence or addition of one or more other features, elements, steps or components, or groups thereof. The scope of the expression ‘a device comprising components A and B’ should therefore not be limited to devices consisting only of components A and B. The meaning is that, with regard to the present invention, only the components A and B of the device are listed, and the claim is further to be interpreted as also including equivalents of these components.

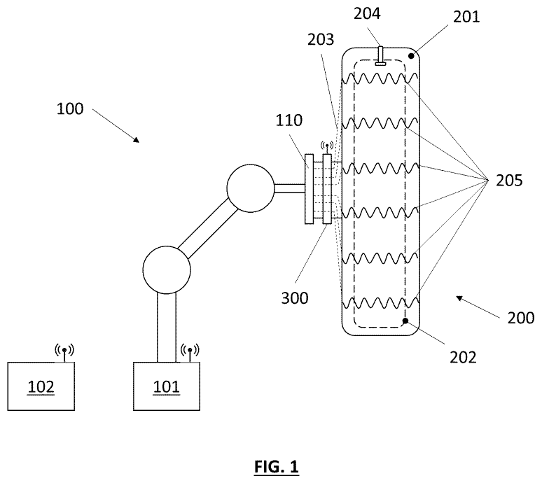

The system shown in FIG. 1 is a rotational moulding system for forming products by means of a rotational moulding process. However, the invention is not limited to this, and may also be applied, for example, in an injection moulding system, or more generally in any system that comprises an electrically heated mould, in which a cavity is provided that determines the shape of a product to be moulded with the mould. The invention is particularly applicable in the rotational moulding systems that are known from the following patent publications of the same applicant and that are incorporated herein by reference: WO 2013/164765A2, WO 2020/104672A1, WO 2020/104673A1, WO 2020/222072A1, WO 2022/189922A1.

The rotational moulding system of FIG. 1 comprises a mould 200 and a device for driving a predetermined movement of the mould, preferably a robotic arm 100. The robot arm 100 comprises a control unit 101 for controlling the robot arm and thus making the mould undergo the predetermined movement. The control unit 101 is preferably also for controlling electrical and electronic components that are provided on the mould 200. Electric currents may be transferred to the mould through a cable that runs along the robot arm and is connected to an interface 110, which is provided at the end of the robot arm. The system may also include a process controller or main control unit 102, as a “master” for the control unit 101 of the robot arm and other components of the system. Communication between the main control unit 102, the control unit 101 and the controlled components may be carried out through wired or wireless communication, preferably wirelessly as shown in the figure.

The mould 200 comprises at least one heatable mould part 201, on which integrated electrical resistors 205 are provided for heating the wall of the mould part 201 and thus also the interior space 202 in the mould. In this way, plastic, which is supplied for example in pellet form into the mould cavity, can be melted before or during the rotational moulding process. The electrical current that is supplied through the resistors 205 for this purpose may be applied via the cable that runs along the robot arm and is connected via the interface 110 to conductors 203 which are in turn connected to the resistors 205. In addition, at least one temperature sensor 204 may be provided on the mould for measuring the temperature in the interior space 202 and/or at one or more places on the mould wall.

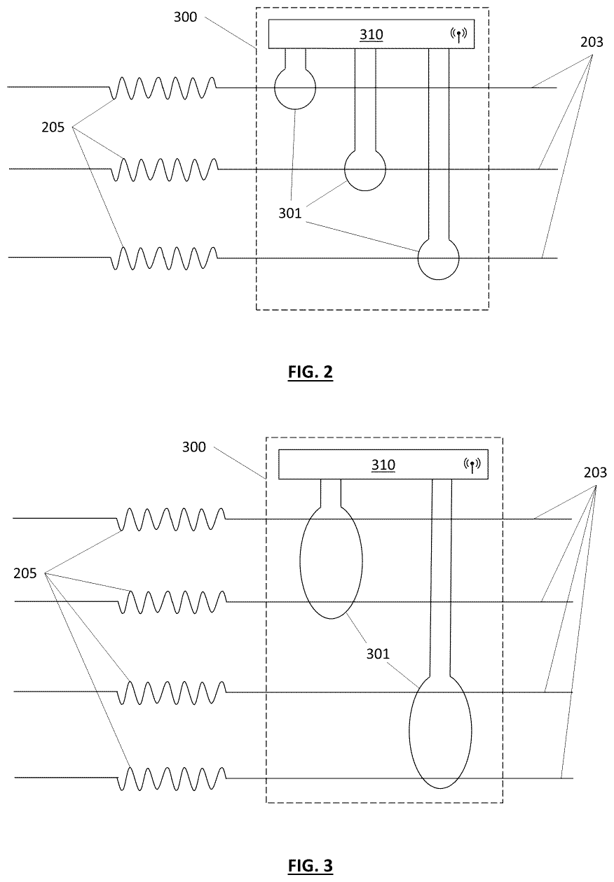

On the mould, preferably on the heatable mould part 201, a measurement device 300 is provided for measuring the electric currents flowing through the conductors 203 that run to the resistors 205. In this way, for example, defective resistors may be detected, wear on the resistors may be monitored, etc. The measurement device 300 is controlled by the main control unit 102 or the control unit 101 of the robot arm 100. FIG. 2-4 schematically shows a few embodiments of the measurement device 300.

The measurement device 300 comprises a plurality of openings, with at least one electrical conductor 203 passing through each opening. Each of these conductors 203 is connected to at least one of the electrical resistors 205 in series. At each opening, an inductive element 301 is provided for measuring the electric current through the respective at least one electrical conductor. The measurement device further comprises electronic components 310 for converting the measured currents into measurement data and for storing and/or transmitting the measurement data. These components may include ADCs for converting analog measurement currents to digital values, a local processing unit, a storage medium, a transceiver for wireless transmission of the measurement data, etc. Such components are known to the skilled person and are therefore not described in further detail herein.

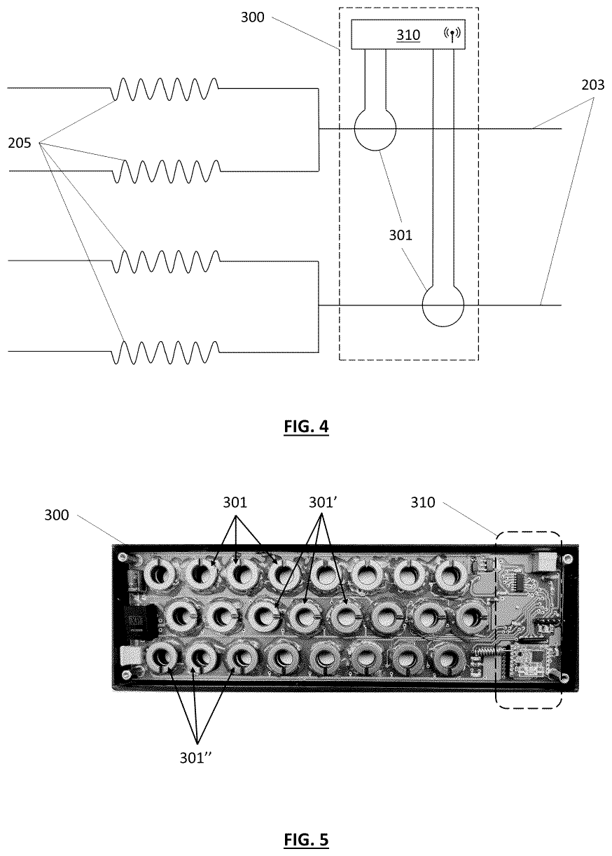

The measurement device preferably comprises a printed circuit board, with the openings and the inductive elements provided on the circuit board as shown in FIG. 5. In this embodiment, the measurement device 300 comprises a number of arrays of inductive elements 301, 301′, 301″ for the individual measurement of currents through conductors. The first array 301 measures the currents through a first group of resistors, the second array 301′measures the currents through a second group of resistors, etc.

FIG. 2 schematically shows an embodiment, like that of FIG. 5, in which each resistor 205 is connected in series to one conductor 203 which is measured individually in the measurement device 300. Each time one conductor 203 runs through each opening of the measurement device, and the current is measured with an inductive element 301, preferably an alternating current transformer. The measured currents are converted by the electronic components 310 into measurement data, which are stored and/or transmitted for further processing, e.g. via a wireless connection to the main control unit 102. The embodiment of FIG. 2 is simple and efficient because the current through each resistor can be measured individually at any time.

FIG. 3 shows another embodiment, in which the resistors 205 are each connected in series to a conductor 203 and the conductors 203 are brought in sets, e.g. in pairs, through the openings of the measurement device 300. In this embodiment, the resistors 205 may for example be measured by applying test currents to a first resistor of the set, then a second of the set, etc. During use, the current through each set of conductors/resistors may also be measured together and compared with one or more threshold values to detect, for example, defects and/or wear on one or more resistors of the set. If a threshold value has been exceeded, test currents may be applied in a separate measurement step to determine which of the resistors of the set is no longer sufficient.

FIG. 4 shows another embodiment, in which each time one conductor 203 is passed through an opening of the measurement device and each conductor is connected to a set of resistors 205. In this embodiment, the resistors 205 may for example be measured by applying test currents to a first resistor of the set, then a second of the set, etc. During use, the current through each set of conductors/resistors may also be measured together and compared with one or more threshold values to detect, for example, defects and/or wear on one or more resistors of the set. If a threshold value has been exceeded, test currents may be applied in a separate measurement step to determine which of the resistors of the set is no longer sufficient.

In the embodiments, like those of FIGS. 3 and 4, switching circuits (not shown) may be provided on the mould for applying currents to a number of the resistors 205, e.g. each time one resistor of a set, or one or more sets of the resistors, etc.

The inductive elements 301 are preferably alternating current transformers. This can have the advantage that the currents flowing through the conductors can be used as a power supply for the measurement device 300. In this way, a separate power source in the measurement device can be avoided. In other embodiments, however, the measurement device may also be equipped with its own power source, such as for example a battery.

The main control unit 102, or the control unit 101 of the robot arm, may be provided for controlling the measurement device to perform current measurements, e.g. via control signals that are sent wirelessly to the measurement device 300. For example, the control unit 101, 102 may be provided for controlling the measurement device to perform a current measurement at least at the beginning and/or at the end of each production cycle, and/or during a production cycle, preferably at regular intervals. In this way, the current measurements may be performed during the production cycles and the production does not have to be interrupted for the measurements. In this way, measurement data may also be collected substantially continuously, or at least at regular intervals during production.

The current measurements may for example have a duration of 1 to 60 seconds, preferably 2 to 30 seconds, more preferably 5 to 10 seconds. For example, in the case of periodic measurements, the current measurements may be repeated at an interval of 20, 30, 40, 50, 60 or more seconds, or every 1, 2, 3 or more minutes, preferably a current measurement once every minute for 5 to 10 seconds.

The current measurements may be repeated periodically during the production cycle, e.g. triggered after the expiry of predetermined time periods after the beginning of the production cycle. The current measurements may also be triggered upon reaching one or more predetermined threshold values for the temperature in the mould or mould wall during the heating of the mould, e.g. every 25° C. or every 50° C., or upon reaching a threshold value of 50° C., 100° C., 150° C., 200° C. and/or 250° C. and/or other predetermined threshold values. The temperature may be measured by means of at least one temperature sensor 204 which is in communicative connection with the control unit 101 or 102 and/or provides measurement data to the measurement unit 300.

1. Product forming system, comprising:
an electrically heated mould of which at least one mould part is provided with a plurality of electrical resistors for heating a cavity inside the mould,
means for applying electric current to the electrical resistors, and
a measurement device for measuring the electric currents flowing through the electrical resistors,
wherein the measurement device is integrated on the mould part and comprises a plurality of openings, wherein at least one electrical conductor runs through each opening, each of which is connected in series to at least one of the electrical resistors,
wherein an inductive element is provided at each opening for measuring the electric current through the respective at least one electrical conductor, and
wherein the measurement device comprises electronic components for converting the measured currents into measurement data and storing and/or transmitting the measurement data.

2. The system according to claim 1, wherein the measurement device comprises a printed circuit board, wherein the openings and the inductive elements are provided on the circuit board.

3. The system according to claim 1, wherein the inductive elements are current transformers.

4. The system according to claim 1, wherein that one conductor runs through each opening.

5. The system according to claim 1, wherein each conductor is connected in series to each time one of the electrical resistors.

6. The system according to claim 1, wherein the system comprises a control unit which is provided for controlling the measurement device to perform the current measurements.

7. The system according to claim 6, characterized in that the control unit is provided for controlling the measurement device to perform a current measurement at least at the beginning and/or the end of each production cycle.

8. The system according to claim 6, wherein the control unit is provided for controlling the measurement device to perform current measurements during a production cycle, preferably at regular intervals.

9. The system according to claim 6, wherein the control unit is provided for controlling the measurement device to perform current measurements upon reaching at least one threshold value for the temperature in the mould cavity or on a wall portion of the mould.

10. The system according to claim 6, wherein each current measurement has a duration of 1 to 60 seconds, preferably 2 to 30 seconds, more preferably 5 to 10 seconds.

11. The system according to claim 1, wherein the electronic components of the measurement device comprise a transceiver, provided for wireless transmission of the measurement data and/or wireless reception of control signals.

12. Method for measuring electric currents flowing through electrical resistors of a product forming system, wherein the product forming system comprises:
an electrically heated mould of which at least one mould part is provided with a plurality of electrical resistors for heating a cavity inside the mould, means for applying electric current to the electrical resistors, and a measurement device for measuring the electric currents flowing through the electrical resistors,
wherein the measurement device is integrated on the mould part and comprises a plurality of openings, wherein at least one electrical conductor runs through each opening, each of which is connected in series to at least one of the electrical resistors,
wherein an inductive element is provided at each opening for measuring the electric current through the respective at least one electrical conductor, and wherein the measurement device comprises electronic components for converting the measured currents into measurement data and storing and/or transmitting the measurement data;
and wherein the method comprises the step of controlling the measurement device, which is integrated on the mould part, to perform a current measurement at least at the beginning and/or the end of each production cycle.

13. Method according to claim 12, wherein the method comprises the step of controlling the measurement device to perform current measurements during a production cycle, preferably at regular intervals.

14. Method according to claim 12, wherein the method comprises the step of controlling the measurement device to perform current measurements during a production cycle upon reaching at least one threshold value for the temperature in the mould cavity or on a wall portion of the mould.

15. Method according to claim 12, wherein each current measurement has a duration of 1 to 60 seconds, preferably 2 to 30 seconds, more preferably 5 to 10 seconds.
